(19) United States
(12) Patent Application Publication
(10) Pub. No.: US 2004/0145971 A1
(43) Pub. Date: Jul. 29, 2004

(54) Watch having faceplate that displays decorative image elements in a sequence of patterns

(76) Inventor: Cheung Ching Lau, Kwal Chung (HK)

Correspondence Address: RABIN & Berdo, PC, 1101 14TH STREET, NW, SUITE 500, WASHINGTON, DC, 20005, US

(21) Appl. No.: 10/352,888

(22) Filed: Jan. 29, 2003

(51) Int. Cl. G04C 19/00

(52) U.S. Cl. 368/84

(57) ABSTRACT

A timepiece has a faceplate that includes a liquid crystal display panel. The LCD panel has electrodes that may be arranged in sectors. The electrodes are driven so as to produce a dynamically changing sequence of patterns.

### BACKGROUND OF THE INVENTION

The present invention is directed a timepiece, and particularly a watch, having dynamic ornamentation that is aesthetically pleasing and that draws attention to the watch.

Most watches in use today are wristwatches. Their primary function is, of course, to display the time, either in a digital manner or in an analog manner (that is, using hands). Because they are very visible and are worn at the position of a bracelet, watches frequently also have a secondary function that is aesthetic in nature. There are several known ways to provide a watch with a pleasing, aesthetic quality. Perhaps the most familiar way is to design it as a piece of jewelry, basically equivalent to a bracelet, using precious metal and also possibly gemstones. Other techniques for improving the aesthetic qualities of a watch include designing it to have a rugged, masculine appearance, using colors that harmonize with different flesh tones or different wardrobes, and so forth.

Digital watches generally employ liquid crystal displays or LCDs. Such displays use groups of image elements to display numbers, with each group having seven elongated segments that can be selectively activated to display a desired digit. Letters and other designations may also be displayed.

Liquid crystal is an organic fluid which, despite being a fluid, has molecules which spontaneously assume an ordered configuration. This configuration can be altered by applying an electric field, and the resulting change in configuration of the molecules can be used to control light passing through the liquid crystal.

A class of liquid crystals known as nematic liquid crystals is frequently used for making electrical displays. The liquid crystal is sandwiched between two polarizing plates bearing transparent electrodes made, for example, from metal oxide film (such as iridium tin oxide, or ITO). The polarization axis of light passing through the first polarizing plate is rotated by the liquid crystal if no voltage is applied between the electrodes, and the degree of rotation decreases or disappears entirely when a voltage is applied. As a result, light passing through the first polarizing plate and the liquid crystal may or may not pass through the second polarizing plate depending upon the applied voltage and hence the polarization axis of the light when it reaches the second polarizing plate. This arrangement can be back-lit, or illuminated from behind, or a mirror can be used to provide a reflective display that relies upon the ambient light. Instead of polarizing plates, transparent but non-polarizing plates can be used in conjunction with independent polarization layers.

Since watches have both the useful function of telling the time and the aesthetic function of looking attractive or drawing attention, it is not surprising that the market for watches is fiercely competitive. Consequently, there is a continuing need for new techniques to improve the appearance of watches and to otherwise heighten their attention-drawing power.

### SUMMARY OF THE INVENTION

A primary object of the present invention is to provide a watch having a faceplate that is provided by an LCD panel and that presents a dynamically changing appearance so as to attract attention. The faceplate may be disposed behind the hands of a watch with an analog movement, or a region of the faceplate may be set aside for use as a time display region in a watch with a digital movement.

Another object is to provide a faceplate using an LCD panel, with the electrodes on at least one side of the panel being divided into groups and with at least one of these groups being symmetrical with respect to at least one other group. All of the groups may be symmetrical. Alternatively, the first set of groups may be symmetrical with one another, the second set of groups may be symmetrical with one another, and so on for any further sets of groups.

A further object is to provide a faceplate using an LCD panel in which electrodes on at least one side of the panel are grouped into symmetrical sectors, with wiring alleys being provided between the groups.

Yet another object is to provide a watch having a faceplate using an LCD panel which is driven so as to display a series of display sequences in which image elements form patterns that appear to evolve.

In accordance with one aspect of the invention, these and other objects which will become apparent from the ensuing detailed description can be attained by providing a watch that includes a watch case with a bezel mounted on it. An LCD panel is disposed below the bezel and has a visible area when viewed through the bezel. This visible area of the LCD panel has a maximum dimension (such as the diameter if the visible area is circular, the major axis if the visible area is elliptical, the length if it is rectangular, and so forth). The LCD panel includes a light-transmitting plate with first and second electrodes on it. The second electrode is electrically connected to the first electrode but is spaced apart from it by a distance that is at least as great as a fourth of the maximum dimension of visible area. Third and fourth electrodes are also disposed on the light-transmitting plate. The third electrode is spaced apart from the first and second electrodes by distances that are at least a fourth as great as the maximum dimension of the visible area. The fourth electrode is electrically connected to the third electrode but is spaced apart from it by a distance that is at least a fourth as great as the maximum dimension of the visible area.

In accordance with another aspect of the invention, a watch includes an LCD panel with a light-transmitting plate. The LCD panel also includes a set of first electrodes disposed on the plate in a first sector, and a set of second electrodes disposed on the plate in a second sector. Each second electrode is paired with one of the first electrodes, and is electrically connected to it.

According to yet another aspect of the invention, a watch has a faceplate that includes an LCD panel with a plate that transmits light, a set of first electrodes on the plate, and a set of second electrodes on the plate. The first electrodes are disposed at predetermined positions in a first sector, and have predetermined sizes and shapes. The second electrodes are disposed in a second sector that is symmetrical with the first sector. Each second electrode corresponds to one of the first electrodes, has substantially the same size and shape as the corresponding first electrode, and is located at a position within the second sector at a position that is substantially the same as the position of the corresponding first electrode within the first sector. Each second electrode is electronically connected to its corresponding first electrode.

### BRIEF DESCRIPTION OF THE DRAWINGS

FIG. 1 illustrates a watch having a faceplate in accordance with a first embodiment of the invention.

FIG. 2 schematically illustrates mechanical and electrical features of the watch.

FIG. 3 illustrates a top plate of an LCD panel in accordance with a first embodiment of the present invention, the top plate having a plurality of symmetrical sectors, with a predetermined number of electrodes in each.

FIG. 4 illustrates the electrodes in one sector on the top plate, identified by different letters which indicate their positions within the sector.

FIG. 5 illustrates electrical connections between the electrodes of two sectors of the top plate and a bus.

FIG. 6 illustrates two sectors of electrodes on a bottom plate of the LCD panel, and how they are connected to a conductor.

FIGS. 7A-7F illustrates a short display sequence in which image elements provide a pattern that appears to evolve.

FIG. 8 illustrates how FIGS. 8A and 8B fit together along a common dot-dash chain line to form a composite figure; and

FIGS. 8A and 8B fit together to form a composite figure showing a light-transmitting plate and electrodes of an LCD panel for a watch in accordance with another embodiment of the invention.

### DESCRIPTION OF THE PREFERRED EMBODIMENTS

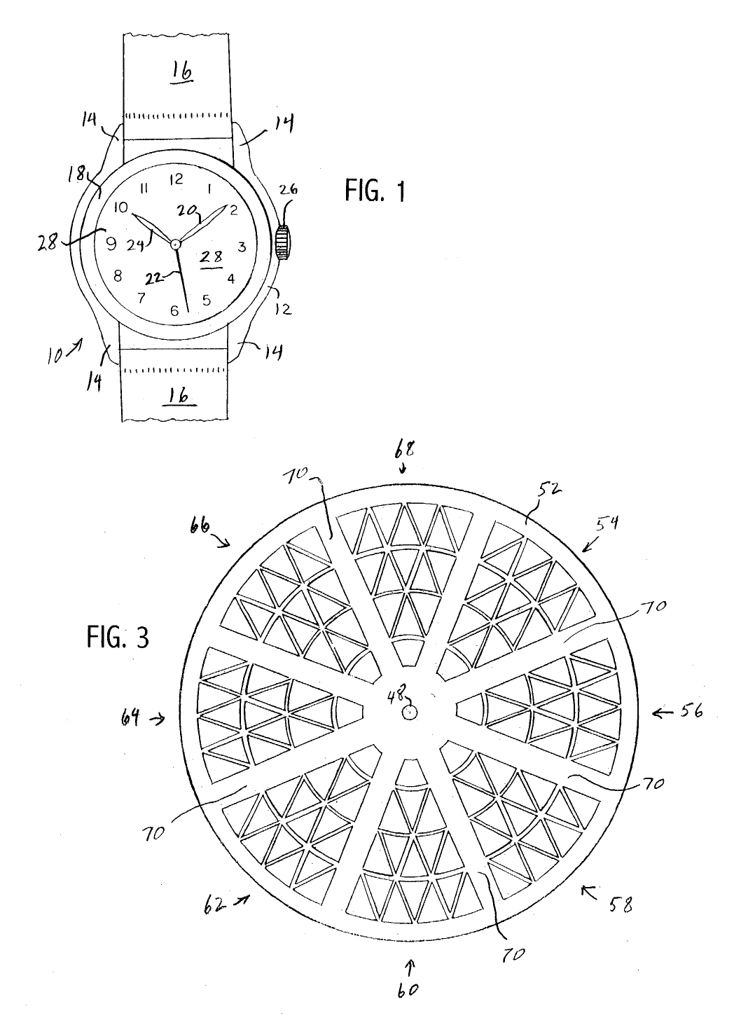

A watch 10 in accordance with the present invention is shown in FIG. 1, and includes a case 12 having flanges 14 for attaching a watchband 16 to the case 12. A bezel 18 is attached to the case 12, and carries a transparent plastic window or so-called crystal (not numbered) that protects the hands of the watch. The watch's hands consist of a minute hand 20, a second hand 22, and an hour hand 24. A watch stem 26 is shown in FIG. 1 in its retracted position. It can be moved outward to a withdrawn position and then rotated to set the hands of the watch, in the usual manner. Below the hands lies a watch face that comprises an LCD panel 28. In FIG. 1 the panel 28 is shown in its quiescent or un-powered state.

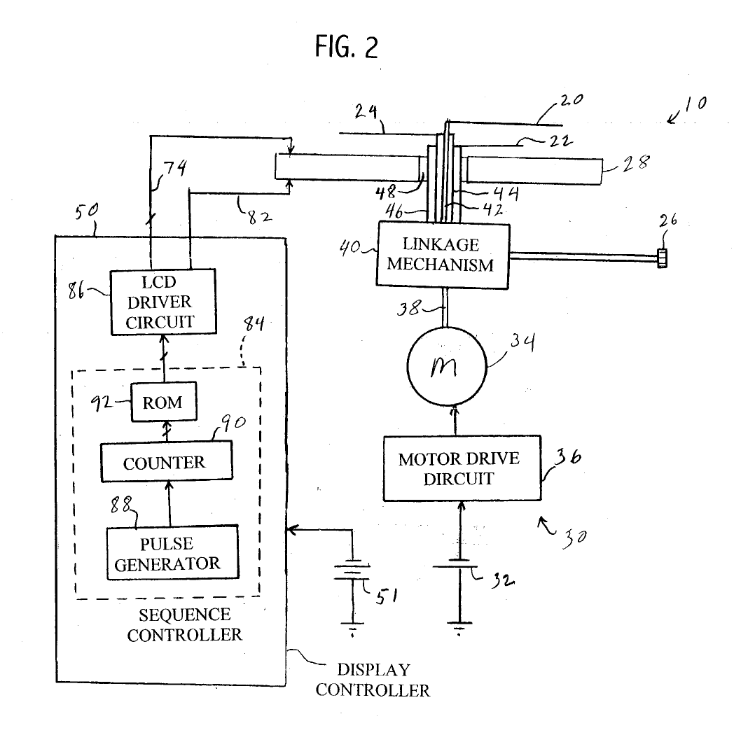

Turning now to FIG. 2, the watch 10 has a so-called “analog movement” 30 that is powered by a cell 32. The analog movement 30 includes a motor 34 which is regulated by a motor drive circuit 36. The motor 34 has a shaft 38 that supplies rotary power to a linkage or transmission mechanism 40, which rotates the hands. The second hand 22 is rotated by way of a shaft 42 extending from the linkage mechanism 40. The shaft 40 extends within and is rotatable with respect to a hollow inner cylinder 44, which carries the minute hand 20 at its outer end. An outer cylinder 46, surrounding the inner cylinder 44 and rotatable with respect to the cylinder 44, carries the hour hand 24 at its outer end. The cylinder 46 extends through a hole 48 in the panel 28. Although not shown, the panel 28 has a sealing agent at the periphery of the hole 48 and at the outer periphery of the panel 28 itself in order to keep the liquid crystal confined and to fix the elements of the panel 28 to one another.

Analog movements suitable for use as analog movement 30 are commercially available.

The watch 10 also includes a display controller 50, which is powered by a battery 51 and which controls the display of the panel 28. The controller 50 will be described in more detail later.

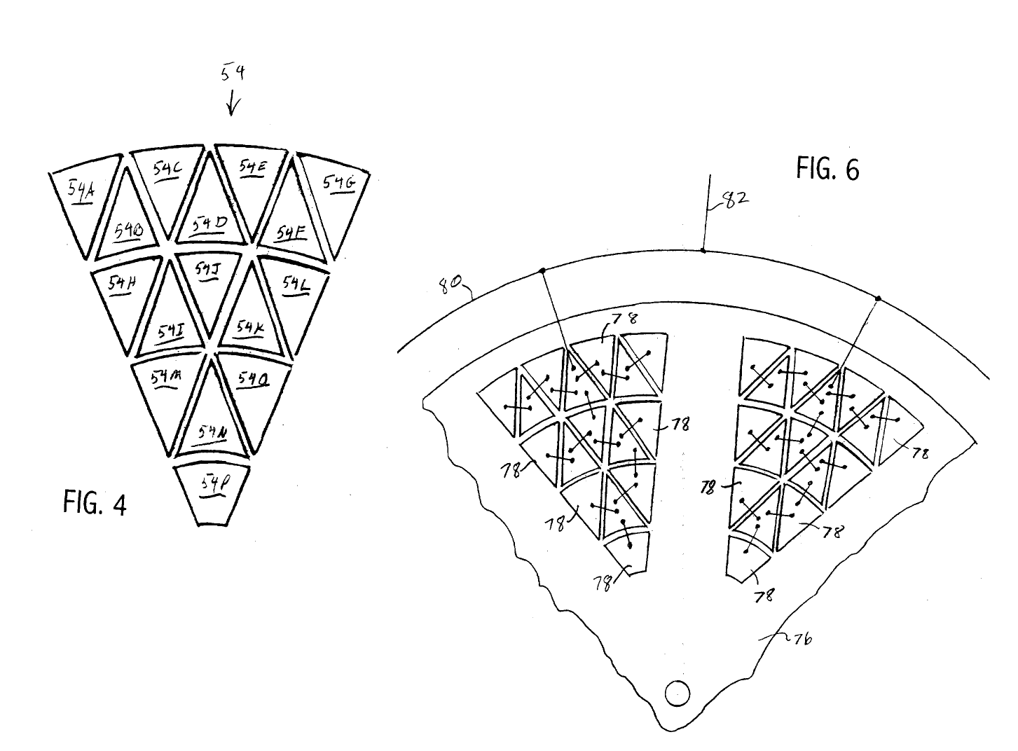

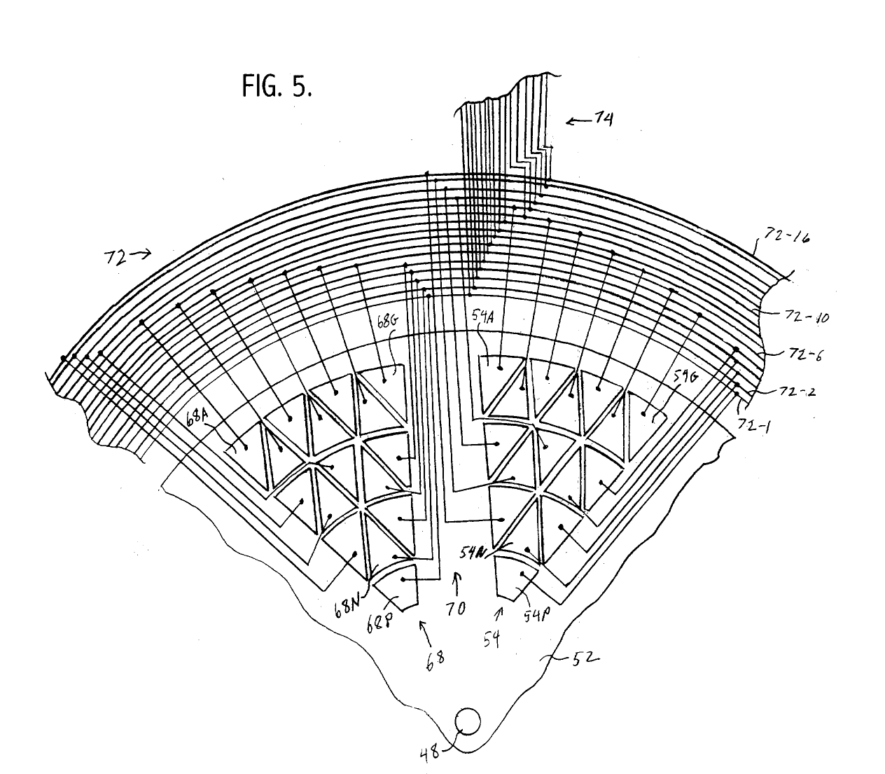

In this embodiment, the LCD panel 28 is a reflective TN (twisted nematic) panel. As is known in the art, a reflective TN LCD panel typically has a stack of layers, including a transparent polarizing first plate (or a non-polarizing plate with an independent polarizer) carrying first transparent electrodes, a liquid crystal layer, a second transparent polarizing plate carrying second transparent electrodes, and a reflector. Light entering the panel via the first plate may or may not be reflected out of the panel by the reflector, depending upon whether voltages placed upon the first and second electrodes rotate the plane polarization of the light in such a manner that the light is blocked by the second polarizing plate. In the present embodiment, the electrodes carried by the first plate (which will hereafter be called the “top” plate) are arranged in a manner that will be described in more detail with reference to FIGS. 3 and 4.

In FIG. 3, the top plate 52 is transparent, and the hole 48 is provided at its center. Electrodes are disposed in eight sectors with eight wiring alleys being provided between the sectors. In FIG. 3, the sectors are identified by reference numbers 54-68. All of the wiring alleys are identified by the same reference number, 70. The width of the wiring alleys 70 is exaggerated in FIG. 3 for the sake of convenient illustration.

Each of the sectors has sixteen transparent electrodes (made, for example, from iridium tin oxide) that are generally triangular in configuration (the innermost triangles being truncated). Hereafter, the electrodes in each sector will be individually identified by letters A through P. To specify a particular electrode in a particular sector, the reference number identifying that sector will be used as a prefix, followed by the particular letter designating the electrode.

The letters A-G will be used to designate the outer seven electrodes of a sector, progressing from A to G in the clockwise direction. One level inward, the next five electrodes are designated by the letters H through L, again in the clockwise direction. The three electrodes in the next level inward are identified by the letters N through 0, in the clockwise direction. The innermost electrode (that is, the one closest to the hole 48) is identified by the letter P. How this system for identifying particular electrodes works is illustrated in FIG. 4 for the sixteen electrodes of sector 54. It should be noted that the spaces between the electrodes are exaggerated, in FIG. 4 and several other figures, for the sake of convenient illustration.

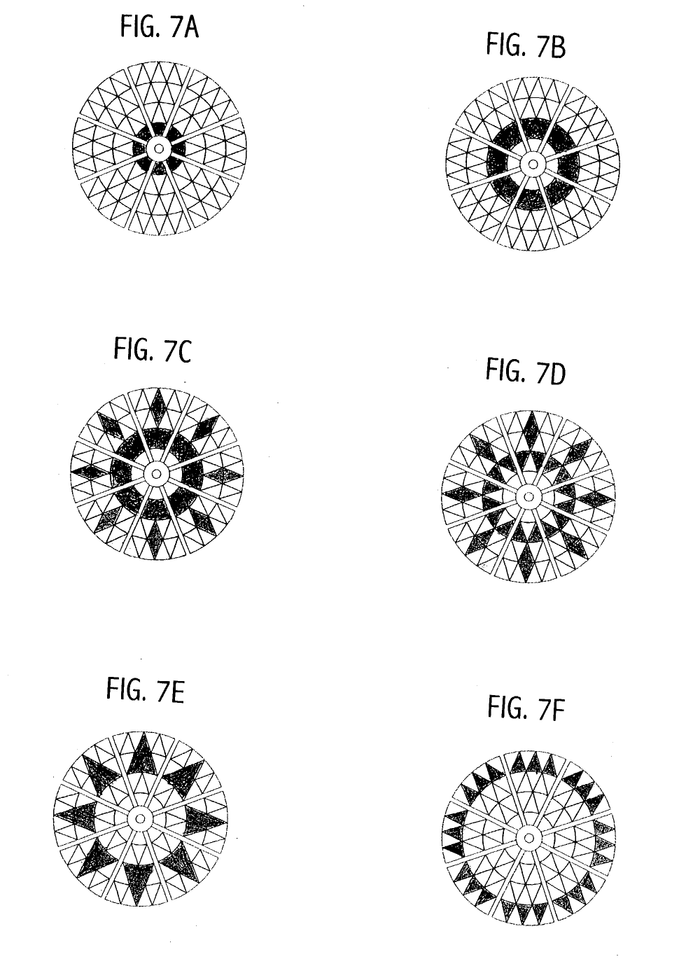

How the electrodes on the top plate 52 are connected in this embodiment is illustrated in FIG. 5. A sixteen-conductor bus 72 surrounds the eight sectors of electrodes. The individual conductors of the bus 72 will be identified by reference numbers 72-1 to 72-16, from the innermost conductor to the outermost conductor, although only a few of the individual conductors are specifically marked with reference numbers in the drawing. The P electrodes of all eight sectors are connected to the conductor 72-1. The N electrodes of all eight sectors are connected to conductors 72-2. In a similar manner, the electrodes in all of the sectors that are identified by the same letter are connected to the same conductor of the bus 72. Although FIG. 5 shows these connections using lines which extend into the interior of the electrodes and terminate in dots, this has been done for the sake of facilitating understanding of the invention and an ordinarily skilled person would appreciate that, in reality, the connections are accomplished by narrow films of ITO that extend from the peripheries of the electrodes. The bus 72 is connected to a further bus 74.

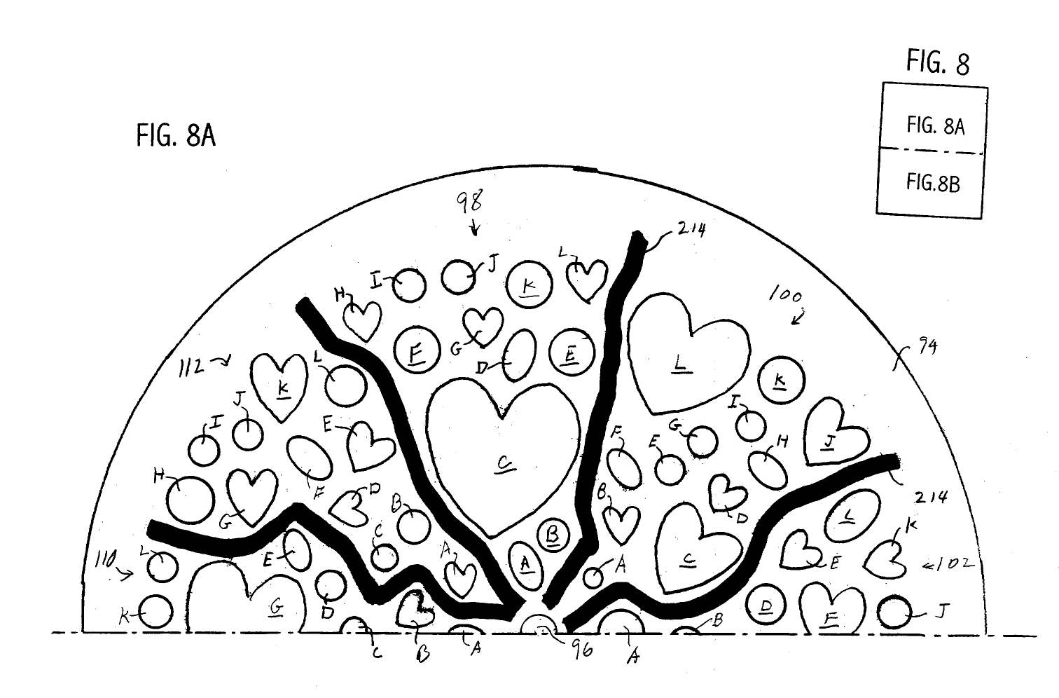

The LCD panel 28 also has a second or bottom plate 76, a portion of which is shown in FIG. 6. In each of the eight sectors, the bottom plate 76 carries 16 generally-triangular transparent electrodes, all of which are identified by reference number 78 in FIG. 6. The electrodes 78 in each sector are connected to a conductor 80 which surrounds the eight sectors of the bottom plate 76. The conductor 80 is, in turn, connected to a conductor 82. The electrodes 78 carried by the bottom plate are disposed directly below electrodes A-P carried by the top plate 52.

Returning, now, to FIG. 2, the display controller 50 includes a sequence controller 84 and an LCD driver circuit 86, which are preferably fabricated as a single IC. The sequence controller 84 includes a pulse generator 88, which generates a pulse stream having a predetermined frequency (such as about one pulse per second) and supplies these pulses to a counter 90. The counter 90 counts pulses up to a predetermined number (such as 1024, or 2¹⁰) and then resets itself to 0. The output of counter 90 is a binary number that is provided to a ROM as address signal for the ROM. At each address, the ROM 92 stores a sixteen-bit word that is supplied to the sectors of the LCD panel 28 by way of the bus 74.

Referring next to FIGS. 2 and 5 together, it is the sixteen-bit words stored in the ROM 92 that determine which of the electrodes A-B in the 8 sectors are activated so as to make an image element visible. These image elements are the visual manifestations of the electrodes A-P when the electrodes are activated. The bits of the words stored in ROM 92 could be selected randomly, so that sequence controller 84 would essentially be a pseudo-random number generator which supplies a pseudo-random number at the predetermined pulse frequency (e.g., about once per second). However, it is also possible to select the bits of the words stored in ROM 92 so that the image elements displayed during one second are usually related in some way to the image elements displayed during the next second, for sequences ranging from a few seconds to many seconds. In this way, the overall impression imparted by the LCD 28 appears to evolve, during the course of a few-to-many second display sequence. Such an evolving display sequence, coupled with the eight-way symmetry provided by the eight sectors, imparts an impression that is similar to an optical kaleidoscope.

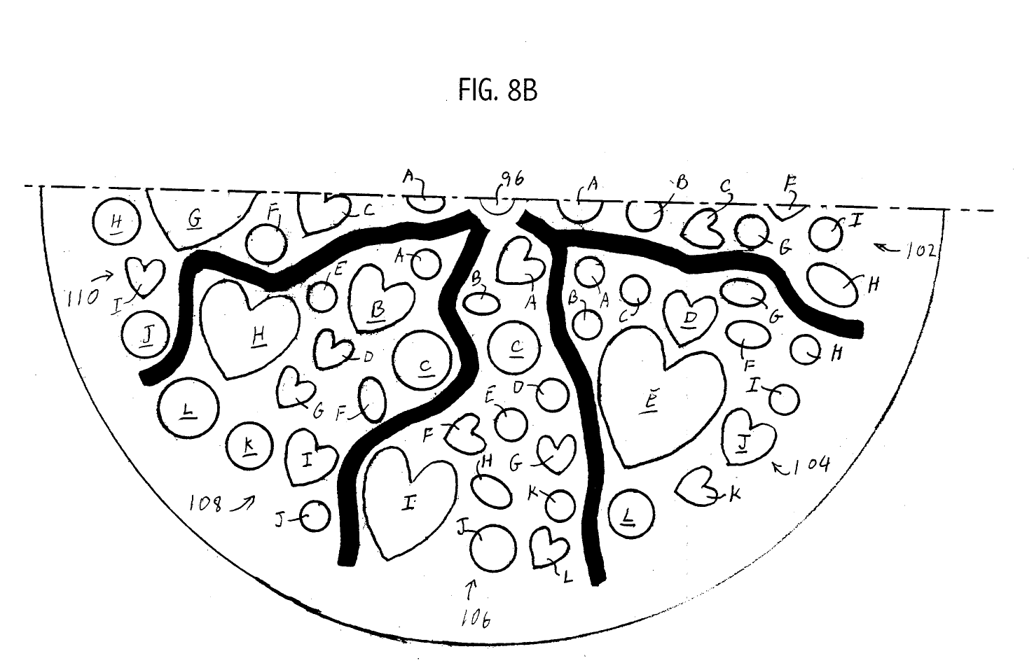

An example is illustrated in FIGS. 7A through 7F, which show a display sequence having six display intervals (each, for example, about a second long in duration). In FIG. 7A, the P electrodes on the top plate 54 are activated, thereby providing a ring of image elements, as shown, in the first interval of the display sequence. In FIG. 7B, the N electrodes are activated. The relation to what is shown in the prior display interval (FIG. 7A) is that the N electrodes lie adjacent the P electrodes. In addition to the N electrodes, the M and the O electrodes are activated in FIG. 7B.

In FIG. 7C, the N-O electrodes remain activated, and also the D and J electrodes. FIG. 7D is the same as FIG. 7C, except that the N electrodes have been deactivated. The D and J electrodes remain activated in FIG. 7E, but the M and 0 electrodes have been deactivated. Additionally, the I and K electrodes have been activated in Figure E.

Finally, in FIG. 7F, the D electrodes remain activated but the I-K electrodes have been deactivated. Additionally, the B and F electrodes, on either side of the D electrodes, have been activated.

It will be apparent that the display sequence illustrated in FIGS. 7A-7F does not convey an impression of mere randomness. Instead, there appears to be an overall theme in this display sequence, with at least one of the display elements during each display interval being related in some way with at least one display element during the next display interval (as by continued activation of the same electrodes or adjacent electrodes). The overall impression imparted by the display sequence shown in FIGS. 7A-7F might be described as a general outward movement, with the ring shown in FIG. 7A growing larger in FIG. 7B and then evolving into more complex but still ring-based images in FIGS. 7C and 7D. These complex images, which have expanded outward from the simple rings shown in FIGS. 7A and 7B, then morph into outward-moving triangles in FIGS. 7E and 7F.

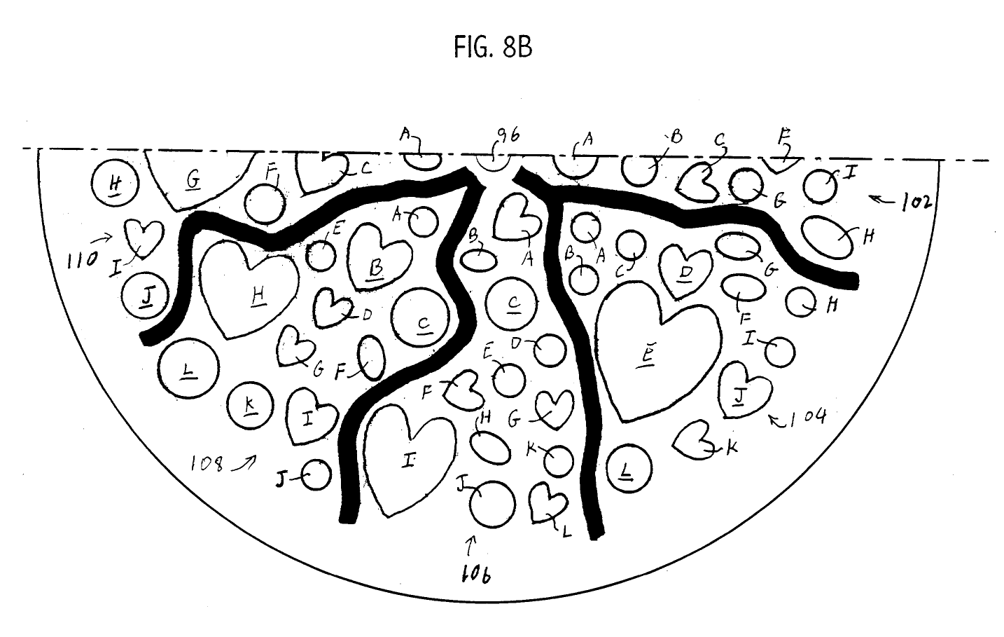

Another embodiment of the present invention will now be described with reference to FIGS. 8A and 8B, which fit together to form a composite drawing as shown in FIG. 8. In this second embodiment, an LCD panel includes a light-transmitting plate 94 having a hole 96 for passage of the shaft 42 and cylinders 44 and 46 (see FIG. 2) of the analog movement 30. Attached to the plate 94 are electrodes that are shaped as circles, ellipses, and hearts. These electrodes have different sizes and orientations. The electrodes are disposed in eight sectors, identified as sectors 98, 100, 102, 104, 106, 108, 110, and 112. Serpentine wiring alleys 214 (depicted in the drawing using broad back lines) are provided between the sectors. The twelve electrodes in each sector are connected to a twelve-conductor bus (not shown) corresponding to the bus 72 shown in FIG. 5. The letters A through L have been used in FIGS. 8A and 8B to identify electrodes that are connected to the same conductor of this bus, and thus to each other. For example, the innermost electrodes are labeled “A” (that is, an elliptical electrode in sector 98, a small circular electrode in sector 100, a large circular electrode in sector 102, a medium circular electrode in sector 104, a medium heart-shaped electrode in sector 106, a medium circular electrode in sector 108, an elliptical electrode in sector 110, and a small heart-shaped electrode in sector 112), and are all connected to the same conductor of the bus. Similarly, all of the electrodes identified with the letter B are connected to the same conductor of the bus, and so forth for the remaining electrodes.

It will be apparent from FIGS. 8A and 8B that some of the electrodes that are connected together via the bus (such as the electrodes labeled L in sectors 98 and 106, or the electrodes labeled I in these sectors) are separated by considerable distances. Typically, the bezel 18 (see FIG. 1) would overlap the periphery of plate 94, thus permitting a viewing area of the LCD panel that is somewhat smaller in expanse than the plate 94 itself. In the example shown in FIGS. 8A and 8B, the distances between the L electrodes in sectors 98 and 106 would be a substantial percentage of the diameter of the viewing area through the bezel.

The LCD panel in this embodiment can be driven by a display controller similar to the display controller 50 shown in FIG. 2. However, the words stored in the ROM 92 would need only 12 bits, instead of 16 as in the first embodiment, in order to specify which of the twelve electrodes in each sector should be activated during each display interval.

Numerous modifications can be made in the embodiments described above without loss of the amusement value provided by the watch 10, and such modifications are intended to be included within the scope of the appended claims. Some of these modifications will be mentioned below.

Although the watch 10 employs an analog movement, it would be possible to use a digital movement instead. With such a modification, a portion of the LCD panel 28 would be configured to display digits. The overall effect would be a window displaying digits representing the current time, with the window being superimposed on or embedded in a decorative region displaying a changing sequence of image elements.

Another modification would be to use a back-lit LCD panel instead of the reflective LCD panel 28. A further modification would be to use a filter to color the backlighting, or to use a liquid crystal of a type that inherently imparts color, or to tint the plate 52.

If a transmission LCD panel is used instead of a reflective one, it can be located above the hands of an analog watch instead of below the hands.

The LCD panel 28 need not be a TN panel. Other types of liquid crystal can be used (for example, STN [super-twisted nematic] or HTN [high-performance twisted nematic]).

Instead of eight sectors, more than eight sectors or fewer than eight sectors may be used. The number of electrodes in each sector is not limited to the sixteen electrodes A-P used in the first embodiment or the twelve electrodes marked A-L used in the second embodiment. A greater number or lesser number may be used.

In the first embodiment described above, for example, all of the A electrodes are activated simultaneously, all of the B electrodes are activated simultaneously, and so on for the remaining electrodes. With reference to the arrangement shown in FIG. 5, this is achieved by connecting all of the A electrodes to the same conductor in the bus 72, all of the B electrodes to the same conductor of the bus 72, and so forth. This provides eight-fold symmetry. However, a more complex arrangement could be achieved by connecting the A electrodes in every other sector to the same conductor and, in the sectors that were skipped over, connecting the B electrodes to this conductor. The remaining A and B electrodes could then be connected to some other conductor of the bus 72. Similarly, half of the C and D electrodes could be connected to the same conductor of bus 72 and the other half could be connected to another conductor, and so on for the remaining electrodes. Another possibility for modification would be to use inverters to invert the activation signals supplied to the electrodes of every other sector.

Although FIG. 2 shows only one ROM 92 and FIG. 5 shows only one bus 72, this arrangement could be modified by connecting the bus 72 to only half of the segments, adding another bus that is connected to the other half, and adding another ROM to store values that are conveyed via the added bus.

The watch 10 may have switches, not shown in FIGS. 1 and 2, to select the operating speed of the LCD panel (such as either about one frame per second in a slow mode or about five frames per second in a fast mode) or to deactivate the LCD panel.

The watch 10 need not have a circular face. For example, it can be rectangular or oval. In such a case, some of the sectors may have more electrodes than other sectors, or the sizes of the electrodes and possibly also their shapes may be adjusted so as to accommodate the same number of electrodes in each sector.

The electrodes of the LCD panel are preferably configured to have decorative shapes. The decorative shapes are not, of course, limited to the specific examples disclosed with respect to the first and second embodiments described herein. Other suitable shapes include rectangles, regular polygons, card suites (spades, hearts, diamonds, and clubs), arrowheads, monetary designations (such as dollar signs, cent signs, yen signs, euro signs, and British pound signs), symbols denoting the zodiac, Xs, astronomical symbols (such as the sun or Sol, stars, ringed or ringless planets, comets, and the moon in a crescent state), silhouettes of clouds, silhouettes of plants such as three or four leaf clovers or flowers, silhouettes of animals such as soaring birds, arcs or rainbows, and smiley-faces. This list is not exhaustive, of course, and other decorative shapes can also be used.

What is claimed is:

1. A watch, comprising:
a watch case;
a bezel mounted on the case; and
an LCD panel below the bezel, the LCD panel having a visible area when viewed through the bezel and the visible area having a maximum dimension; the LCD panel including
a light-transmitting plate,
a first electrode disposed on the plate,
a second electrode disposed on the plate at a position that is spaced apart from the first electrode by a distance that is at least a fourth as great as the maximum dimension of the visible area, the second electrode being electrically connected to the first electrode,
a third electrode disposed on the plate at a position that is spaced apart from the first electrode by a distance that is at least a fourth as great as the maximum dimension of the visible area and that is also spaced apart from the second electrode by a distance that is at least a fourth as great of the maximum dimension of the visible area,
a fourth electrode disposed on the plate at a position that is spaced apart from the third electrode by a distance that is at least a fourth as great as the maximum dimension of the visible area, the fourth electrode being electrically connected to the third electrode but not to the first electrode or the second electrode.

2. The watch of claim 1, wherein the visible area of the LCD panel is substantially circular and the maximum dimension of the visible area is its diameter, wherein the second electrode is spaced apart from the first electrode by a distance that is at least half as great as the diameter, wherein the third electrode is spaced apart from the first electrode by a distance that is at least half the diameter and is also spaced apart from the second electrode by a distance that is at least half the diameter, and wherein the fourth electrode is spaced apart from the third electrode by a distance that is at least half the diameter.

3. The watch of claim 2, wherein the second electrode is spaced apart from the first electrode by a distance that is at least two thirds as great as the diameter, wherein the third electrode is spaced apart from the first electrode by a distance that is at least two thirds the diameter and is also spaced apart from the second electrode by a distance that is at least two thirds the diameter, and wherein the fourth electrode is spaced apart from the third electrode by a distance that is at least two thirds the diameter.

4. The watch of claim 1, wherein the first electrode and third electrodes have substantially the same size and shape, and wherein the second and fourth electrodes have substantially the same size and shape.

5. The watch of claim 1, wherein the electrodes have shapes that are selected from the group consisting of triangles, rectangles, regular polygons, hearts, clubs, spades, diamonds, circles, ovals, arrowheads, dollar signs, yen signs, euro signs, British pound signs, symbols denoting the zodiac, Xs, stars, the sun or Sol, ringless planets, ringed planets, comets, crescents, silhouettes of clouds, silhouettes of three or four leaf clovers, silhouettes of flowers, silhouettes of soaring birds, arcs or rainbows, and smiley-faces.

6. A watch, comprising:
a light-transmitting plate;
a set of first electrodes disposed on the plate in a first sector; and
a set of second electrodes disposed on the plate in a second sector, each second electrode being paired with one of the first electrodes and being electrically connected to the paired first electrode.

7. The watch of claim 6, wherein the light-transmitting plate has a central portion, wherein the first and second sectors are disposed on opposite sides of the central portion, and wherein there are at least eight first electrodes and eight second electrodes.

8. The watch of claim 7, wherein the first and second electrodes have decorative shapes.

9. A timepiece, comprising:
an LCD panel that includes
a light-transmitting plate,
a set of first electrodes disposed on the plate in a first sector, the first electrodes being located at predetermined positions within the first sector and having predetermined sizes and shapes, and
a set of second electrodes disposed on the plate in a second sector that is symmetrical with respect to the first sector, each second electrode corresponding to one of the first electrodes and having a size and shape that are substantially the same as the size and shape of the corresponding first electrode, each second electrode being located at a position within the second sector that is substantially the same as the position of the corresponding first electrode within the first sector, each second electrode being electrically connected to the corresponding first electrode.

10. The timepiece of claim 9, wherein the LCD panel further includes:
a set of third electrodes disposed on the plate in a third sector that is symmetrical with respect to the first sector, each third electrode corresponding to one of the first electrodes and having a size and shape that are substantially the same as the size and shape of the corresponding first electrode, each third electrode being located at a position within the third sector that is substantially the same as the position of the corresponding first electrode within the first sector, each third electrode being electrically connected to the corresponding first electrode, and
a set of fourth electrodes disposed on the plate in a fourth sector that is symmetrical with respect to the first sector, each fourth electrode corresponding to one of the first electrodes and having a size and shape that are substantially the same as the size and shape of the corresponding first electrode, each fourth electrode being located at a position within the fourth sector that is substantially the same as the position of the corresponding first electrode within the first sector, each fourth electrode being electrically connected to the corresponding first electrode.

11. The timepiece of claim 10, wherein the LCD panel further includes:
a set of fifth electrodes disposed on the plate in a fifth sector that is symmetrical with respect to the first sector, each fifth electrode corresponding to one of the first electrodes and having a size and shape that are substantially the same as the size and shape of the corresponding first electrode, each fifth electrode being located at a position within the fifth sector that is substantially the same as the position of the corresponding first electrode within the first sector, each fifth electrode being electrically connected to the corresponding first electrode, and
a set of sixth electrodes disposed on the plate in a sixth sector that is symmetrical with respect to the first sector, each sixth electrode corresponding to one of the first electrodes and having a size and shape that are substantially the same as the size and shape of the corresponding first electrode, each sixth electrode being located at a position within the sixth sector that is substantially the same as the position of the corresponding first electrode within the first sector, each sixth electrode being electrically connected to the corresponding first electrode.

12. The timepiece of claim 11, wherein the LCD panel further includes:
a set of seventh electrodes disposed on the plate in a seventh sector that is symmetrical with respect to the first sector, each seventh electrode corresponding to one of the first electrodes and having a size and shape that are substantially the same as the size and shape of the corresponding first electrode, each seventh electrode being located at a position within the seventh sector that is substantially the same as the position of the corresponding first electrode within the first sector, each seventh electrode being electrically connected to the corresponding first electrode, and
a set of eighth electrodes disposed on the plate in a eighth sector that is symmetrical with respect to the first sector, each eighth electrode corresponding to one of the first electrodes and having a size and shape that are substantially the same as the size and shape of the corresponding first electrode, each eighth electrode being located at a position within the eighth sector that is substantially the same as the position of the corresponding first electrode within the first sector, each eighth electrode being electrically connected to the corresponding first electrode.

13. The timepiece of claim 12, wherein the sectors are generally triangular in shape, and are disposed around a central region of the LCD panel like pieces of pie.

14. The timepiece of claim 13, wherein the first, second, third, fourth, fifth, sixth, seventh, and eighth electrodes are generally triangular in shape.

15. The timepiece of claim 13, wherein the LCD panel has a top side and a bottom side, the light-transmitting plate being disposed at the top side, wherein the LCD panel has a through-hole in a central region thereof, and further comprising a plurality of hands above the top side of the LCD panel, an analog movement below the bottom side of the LCD panel, and means for connecting the hands to the analog movement, the means extending through the hole in the LCD panel.

16. The timepiece of claim 15, further comprising means for activating the electrodes so as to dynamically display image elements in a sequence of changing patterns.

17. The timepiece of claim 18, wherein the sequence of changing patterns includes a display sequence that evolves.

18. The timepiece of claim 9, wherein the sectors are generally triangular in shape, and are pointed toward a central region of the LCD panel.

19. The timepiece of claim 18, wherein the first and second electrodes are generally triangular in shape.

20. The timepiece of claim 18, wherein the LCD panel has a top side and a bottom side, the light-transmitting plate being disposed at the top side, wherein the LCD panel has a through-hole in a central region thereof, and further comprising a plurality of hands above the top side of the LCD panel, an analog movement below the bottom side of the LCD panel, and means for connecting the hands to the analog movement, the means extending through the hole in the LCD panel.

21. The timepiece of claim 18, further comprising means for activating the electrodes so as to dynamically display image elements in a sequence of changing patterns.

22. The timepiece of claim 21, wherein the sequence of changing patterns includes a display sequence that evolves.

23. The timepiece of claim 21, wherein the means for activating the electrodes comprises a ROM that stores words which specify the patterns.

24. The timepiece of claim 23, wherein the ROM stores at lease 1024 words.

25. The timepiece of claim 9, wherein the timepiece is a wristwatch.

26. The timepiece of claim 25, wherein the watch is an analog watch having movable hands and a faceplate below the hands, and wherein the LCD panel serves as the faceplate of the watch.
